(19) United States
(12) Patent Application Publication
(10) Pub. No.: US 2007/0043573 A1
(43) Pub. Date: Feb. 22, 2007

(54) Method and apparatus for speech input

(75) Inventors: Yuan-Chia Lu, Taipei City (TW); Jia-Lin Shen, Taipei City (TW); Jimho Tsai, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan County (TW)

(21) Appl. No.: 11/500,534

(22) Filed: Aug. 8, 2006

(30) Foreign Application Priority Data
Aug. 22, 2005 (TW) 094128653

(51) Int. Cl. G10L 21/00

(52) U.S. Cl. 704/275

(57) ABSTRACT

A method for a speech input is provided. The method includes steps of: (a) establishing a hierarchical command list having a plurality of classified commands and a plurality of predetermined commands in a first device, (b) issuing a first speech command to the first device from a third device of a second device so that the first device obtains a first classified command corresponding to the first speech command, (c) determining a first command set from the plurality of predetermined commands via the first device based on the first classified command, (d) controlling the first device by the third device so as to cyclically provide each command in the first command set, (e) issuing a second speech command according to the each command in the first command set, (f) recognizing the second speech command with the first device, and (g) performing an operation corresponding to the recognized second speech command.

### FIELD OF THE INVENTION

The present invention relates to the method and the system for a speech input, and more particular to the method and the system for a speech input of a headset device.

### BACKGROUND OF THE INVENTION

The wireless electronic device has become more popular due to the property of the remote operation capacity and the getting mature techniques thereof. At present, various electronic devices with the capability of transmitting data via wireless techniques have been provided. Nevertheless, the current wireless headset device, such as the infrared-ray wireless earphone and the bluetooth wireless earphone, is used as the medium for the two-way communication of information.

In order to answer the digital trend, the user always would like to control the surrounding electronic devices directly via the wireless headset deice by means of using the wireless headset device. Nevertheless, one of the defects of the current wireless electronic device is that the input and output interface thereof is not friendly enough and the user always could not operate the wireless electronic device at his will. In order to solve the problems regarding the information communication between wireless electronic devices, lots of studies for the information communication have been made. One popular way to increase the convenience of the communication between wireless electronic devices is the friendly human input interface, such as the speech input interface, whereby the user could transmit a command directly via a speech.

In addition, since the computing ability of the current electronic device is not so powerful and the user could not give a command arbitrarily, it is desirous to provide a mechanism to increase the success rate of the speech recognition.

In order to increase the success rate of the speech recognition of the wireless electronic device and the convenience of operating the wireless electronic device, the present invention provides the new method and system for a speech input. In the present invention, a hierarchical guide mechanism is provided.

### SUMMARY OF THE INVENTION

In accordance with one respect of the present invention, a method for speech input is provided. The method includes steps of: (a) establishing a hierarchical command list having a plurality of classified commands and a plurality of predetermined commands in a first device, (b) issuing a first speech command to the first device from a third device of a second device so that the first device obtains a first classified command corresponding to the first speech command, (c) determining a first command set from the plurality of predetermined commands via the first device based on the first classified command, (d) controlling the first device by the third device so as to cyclically provide each command in the first command set, (e) issuing a second speech command according to the each command in the first command set, (f) recognizing the second speech command with the first device, and (g) performing an operation corresponding to the recognized second speech command.

Preferably, the first device is a processor.

Preferably, the second device is a wireless electronic device.

Preferably, the wireless electronic device is a headset.

Preferably, the third device is a key.

Preferably, the step b) includes steps of: b1) providing the plurality of determined classified commands by the first device, and b2) issuing the first speech command after the first device provides a desired classified command.

Preferably, the step by includes steps of: b1) providing the plurality of determined classified commands by controlling the first device with the third device, and b2) issuing the first speech command after the first device provides a desired classified command.

In accordance with another respect of the present invention, a speech operating method for a wireless electronic device having a key and wirelessly communicating with a processor device is provided. The method includes steps of: a) establishing a hierarchical command list having a plurality of classified commands arranged in a plurality of levels and a plurality of predetermined commands in the processor device, b) selecting a first classified command in a level by controlling the key, c) sending a first speech command according to the first classified command, d) providing a second classified command in a sublevel by the processor device according to the first speech command, e) finding out a final classified command by repeating the steps b) to d), f) providing a command corresponding to the final classified command to the wireless electronic device from the processor device, g) sending a second speech command according to the provided command in the step of f), h) recognizing the second speech command by the processor device, and i) performing an operation corresponding to the second speech by the processor device.

Preferably, the wireless electronic device is a headset.

Preferably, the processor device is a mobile phone.

Preferably, the processor device is a personal digital assistant.

In accordance with another respect of the present invention, a speech input system is provided. The speech input system includes a main device and a wireless electronic device. The main device has a speech recognition system, a first command transmitter electrically connected with the speech recognition system, and a first command receiver electrically connected with the speech recognition system. The wireless electronic device wirelessly communicates with the main device has a second command transmitter, a second command receiver electrically connected with the second command transmitter, a key electrically connected with second command transmitter, a sound device electrically connected with the second command receiver and a speech receiver electrically connected with the second command transmitter.

Preferably, the wireless electronic device is a headset.

Preferably, the main device is a mobile phone.

Preferably, the main device is a personal digital assistant.

The foregoing and other features and advantages of the present invention will be more clearly understood through the following descriptions with reference to the drawings, wherein:

### BRIEF DESCRIPTION OF THE DRAWING

FIG. 1 is a diagram showing the speech input system according to a preferred embodiment of the present invention;

FIG. 2 is a diagram showing a hierarchical command tree according to a preferred embodiment of the present invention; and

FIG. 3 is a diagram showing a hierarchical command tree according to another preferred embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

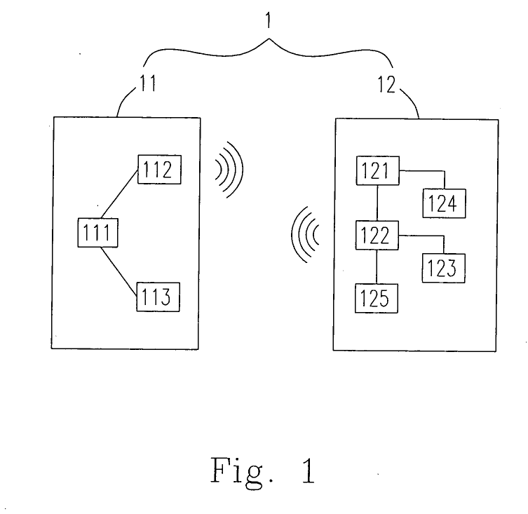

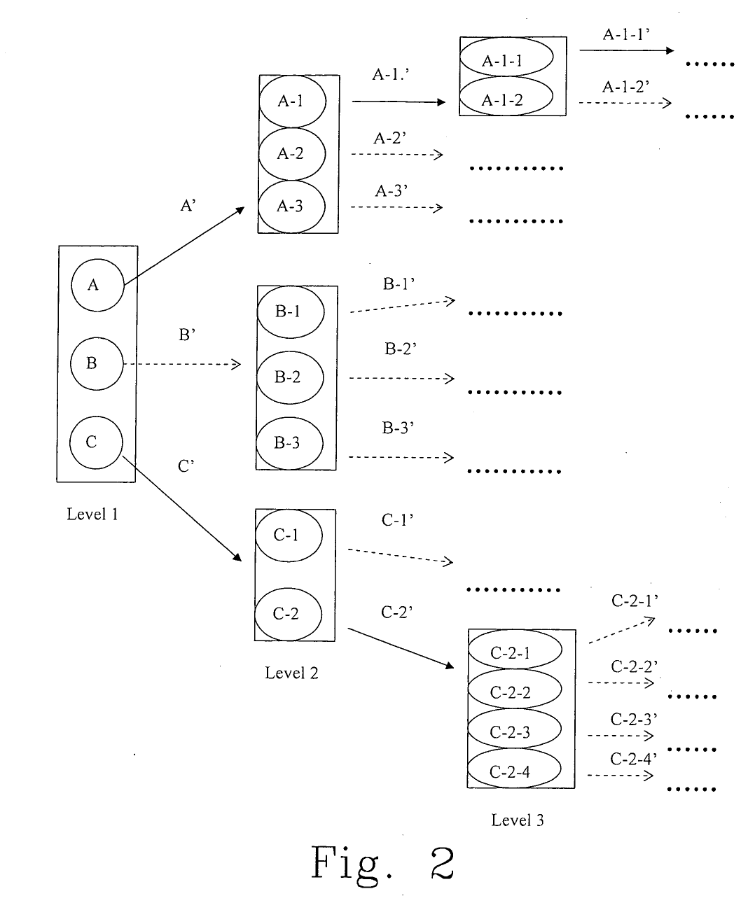

Please refer to FIG. 2, which is a diagram showing the speech input system according to a preferred embodiment of the present invention. As shown in FIG. 1, the speech input system 1 includes a main device 11, such as a processor, a PDA or a cell phone, and a wireless electronic device 12, such as a bluetooth earphone or other headsets. The main device 11 includes a speech recognition system 111, a predetermined command transmitter 112 and a command receiver 113. The wireless electronic device 12 includes a predetermined command receiver 121, a command transmitter 122, a key 123, a predetermined command sound device 124 and a speech command receiver 125. The speech recognition system 111 includes a hierarchical command tree having a plurality of classified commands, a plurality of predetermined commands and a plurality of potential speech commands.

Please refer to FIG. 2, which is a diagram showing a hierarchical command tree according to an embodiment of the present invention. As shown in FIG. 2, A, B and C are the classified commands, A-1, A-2, A-3, A-1-1, A-1-2, B-1, B-2, B-3, C-1, C-2, C-2-1, C-2-2, C-2-3, and C-2-4 are the predetermined commands, and A′, B′,C′, A-1′, A-2′, A-3′, A-1-1′, A-1-2′, B-i′, B-2′, B-3′, C-i′, C-2′, C-2-l′, C-2-2′, C-2-3′, and C-2-4′ are the potential speech commands.

Please refer to FIGS. 1 and 2, during the operation of the speech input system 1, the main device 11 would transmit the classified command A in Level 1 to the wireless electronic device 12 via the predetermined command transmitter 112 and the predetermined command receiver 121. Then, the predetermined command sound device 124 would inform a user (not shown) with the classified command A After understanding the classified command A, the user would determine whether the classified command A is desired. If the classified command A is desired, the user could provide a speech command A′ associated with the classified command A. After the speech command receiver 125 receives the speech command A′, the received speech command A′ would be transmitted to the command receiver 113 via the command transmitter 122. After that, the received speech command A′ would be transmitted to the speech recognition system 111 and recognized thereby. Then, the operation goes to the next level, i.e. Level 2.

When the relevant operation goes to Level 2, the main device 11 transmits the predetermined command A-1 to the wireless electronic device 12, and then the predetermined command sound device 124 would inform the user with the predetermined command A-1. After understanding the predetermined command A-1, the user would determine whether the predetermined command A-1 is desired. If the predetermined command A-1 is desired, the user could provide a speech command A-1′ associated with the predetermined command A-1. After the speech command receiver 125 receives the speech command A-1′, the received speech command A-1′ would be transmitted to the speech recognition system 111 via the command transmitter 122 and command receiver 113 and then recognized thereby. Then, the operation will go to the next level, i.e. Level 3.

When the relevant operation goes to Level 3, the main device 11 transmits the predetermined command A-1-1 to the wireless electronic device 12 via the predetermined command receiver 121, and then the predetermined command sound device 124 would inform the user with the predetermined command A-1-1. After understanding the predetermined command A-1-1, the user would determine whether the predetermined command A-1-1 is desired. If the predetermined command A-1-1 is desired, the user could provide a speech command A-1-1′ associated with the predetermined command A-1-1. After the speech command receiver 125 receives the speech command A-1-1′, the received speech command A-1-1′ would be transmitted to the speech recognition system 111 via the command transmitter 122 and command receiver 113 and then recognized thereby. After recognition, the main device 11 would carry out the action indicated by the speech command A-1-1′.

Please refer to FIGS. 1 and 2 again. During the operation of the speech input system 1, the main device 11 would transmit the classified command A in Level 1 to the wireless electronic device 12 via the predetermined command transmitter 112. Then, the predetermined command sound device 124 would inform a user (not shown) with the classified command A. After understanding the classified command A, the user would determine whether the classified command A is desired. If the classified command A is undesired, the user could press the key 123 to provide a first information (not shown) to the main device 11 via the command transmitter 122 and the command receiver 113. Then the main device 11 would provide the classified command B to the wireless electronic device 12. Then, the predetermined command sound device 124 would inform the user with the classified command B. After understanding the classified command B, the user would determine whether the classified command B is desired. If the classified command B is undesired, the user could press the key 123 again to provide a second information (not shown) to the main device 11 via the command transmitter 122 and the command receiver 113. Then the main device 11 would provide the classified command C to the wireless electronic device 12. After understanding the classified command C, the user would determine whether the classified command C is desired. If the classified command C is desired, the user could provide a speech command C′ associated with the classified command C. After the speech command receiver 125 receives the speech command C′, the received speech command C′ would be transmitted to the command receiver 113 via the command transmitter 122. After that, the received speech command C′ would be transmitted to the speech recognition system 111 and recognized thereby. Then, the operation goes to the next level, i.e. Level 2.

When the relevant operation goes to Level 2, the main device 11 transmits the predetermined command C-1 to the wireless electronic device 12, and then the predetermined command sound device 124 would inform the user with the predetermined command C-1. After understanding the predetermined command C-1, the user would determine whether the predetermined command C-1 is desired. If the predetermined command C-1 is undesired, the user could press the key 123 to provide a third information (not shown) to the main device 11 via the command transmitter 122 and the command receiver 113. Then the main device 11 would provide the predetermined command C-2 to the wireless electronic device 12. After understanding the predetermined command C-2, the user would determine whether the predetermined command C-2 is desired. If the predetermined command C-2 is desired, the user could provide a speech command C-2′ associated with the classified command C-2. After the speech command receiver 125 receives the speech command C-2′, the received speech command C-2′ would be transmitted to the command receiver 113 via the command transmitter 122. After that, the received speech command C-2′ would be transmitted to the speech recognition system 111 and recognized thereby. Then, the operation goes to the next level, i.e. Level 3. Similar to the above illustrations, the operation goes to the communications about the predetermined commands C-2-1, C-2-2, C-2-3 and C-2-4. As above, the user could find out the desired predetermined command by the hierarchical communication mechanism.

Please refer to FIGS. 1 and 2 again. It is to be noted that when the operation in within Level 1, the user could only select the classified commands A, B or C via the key 123. After the desired classified command is found, the operation goes to Level 2. Then, the main device 11 determines the next predetermined commands according to the relevant selected parent nodes (i.e. the classified commands A, B or C). For example, if the classified command A is desired and selected, the predetermined commands provided in Level 2 would be A-1, A-2 and A-3 rather than B-1, B-2, B-3, C-1 and C-2. As above, after the hierarchical selection and communication, the user would find out the desired speech command by the suggestion of the speech input system 1.

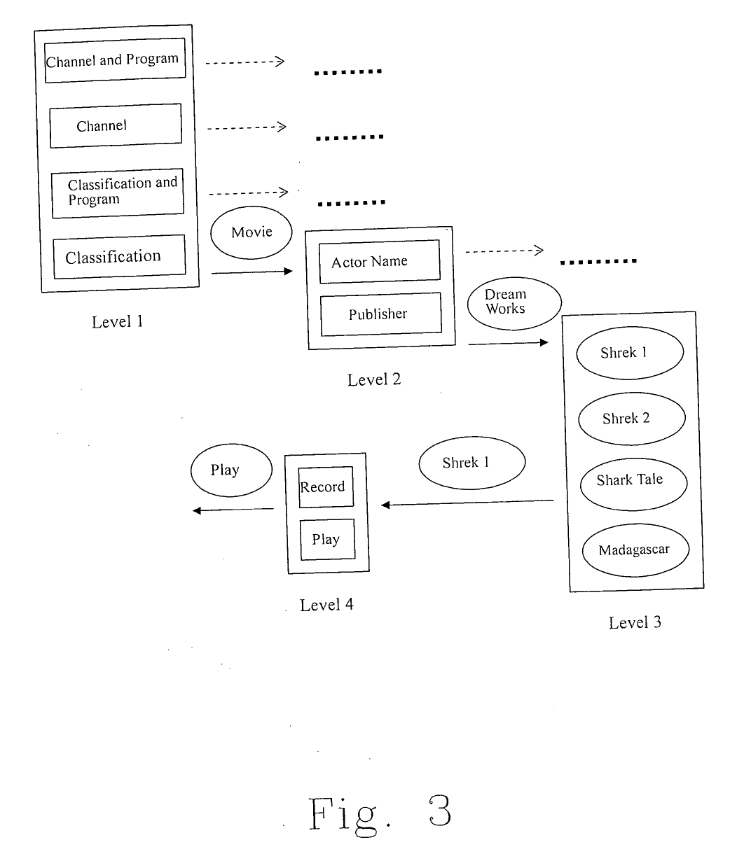

Please refer to FIG. 3, which shows a hierarchical tree according to another embodiment of the present invention.

Please refer to FIGS. 1 and 3. During the operation, the user could select the desired classified command from the predetermined commands, “channel and program”, “channel”, “classification and program” and “classification” via the key 123. If the user selects the classified command “classification” and then provides a speech command “movie”, the speech recognition system 11 would recognize the speech command. After the speech recognition system 11 recognizes the speech command “movie”, the main device 11 would prompt the predetermined commands, “actor name” and “publisher”, in Level 2 and then the user could select the desired predetermined classified command via the key 123. If the user provides a speech command “Dream Work” while the predetermined command “publisher” is selected, the speech recognition system 11 would recognize the speech command. After the speech recognition system 11 recognizes the speech command “Dream Works”, the main device 11 would prompt the predetermined commands, “Shrek 1”, “Shrek 2”, “Shark Tale” and “Madagascar”, in Level 3 and then the user could select the desired predetermined classified command via the key 123 again. If the user provides the speech command “Play” while the predetermined command “Shrek 1” is selected, and then the main device 11 would send a signal to the playing device(such as DVD player) to play the movie immediately.

As mentioned above, it is believed that one skilled in the art should understand that the present invention provides the method and system relating to the provision of the speech suggestion and the control via a key for a command input. In addition, with the provided hierarchical guide mechanism and the key, it is possible for the user to provide a proper speech command to increase the recognition rate of the relevant device and the correctness of the action of the relevant devices. As mentioned above, the present invention indeed has novelty, progressiveness and industry application.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claim is:

1. A method for speech input, comprising steps of:
(a) establishing a hierarchical command list having a plurality of classified commands and a plurality of predetermined commands in a first device;
(b) issuing a first speech command to the first device from a third device of a second device so that the first device obtains a first classified command corresponding to the first speech command;
(c) determining a first command set from the plurality of predetermined commands via the first device based on the first classified command;
(d) controlling the first device by the third device so as to cyclically provide each command in the first command set;
(e) issuing a second speech command according to the each command in the first command set;
(f) recognizing the second speech command with the first device; and
(g) performing an operation corresponding to the recognized second speech command.

2. The method according to claim 1, wherein the first device is a processor.

3. The method according to claim 1, wherein the second device is a wireless electronic device.

4. The method according to claim 3, wherein the wireless electronic device is a headset.

5. The method according to claim 4, wherein the third device is a key.

6. The method according to claim 1, wherein the step b) comprises steps of:
b1) providing the plurality of determined classified commands by the first device; and
b2) issuing the first speech command after the first device provides a desired classified command.

7. The method according to claim 1, wherein the step b) comprises steps of:
b1) providing the plurality of determined classified commands by controlling the first device with the third device; and
b2) issuing the first speech command after the first device provides a desired classified command.

8. A speech operating method for a wireless electronic device having a key and wirelessly communicating with a processor device, comprising steps of:
a) establishing a hierarchical command list having a plurality of classified commands arranged in a plurality of levels and a plurality of predetermined commands in the processor device;
b) selecting a first classified command in a level by controlling the key;
c) sending a first speech command according to the first classified command;
d) providing a second classified command in a sublevel by the processor device according to the first speech command;
e) finding out a final classified command by repeating the steps b) to d);
f) providing a command corresponding to the final classified command to the wireless electronic device from the processor device;
g) sending a second speech command according to the provided command in the step of f);
h) recognizing the second speech command by the processor device; and
i) performing an operation corresponding to the second speech by the processor device.

9. The speech operating method according to claim 8, wherein the wireless electronic device is a headset.

10. The speech operating method according to claim 8, wherein the processor device is a mobile phone.

11. The speech operating method according to claim 8, wherein the processor device is a personal digital assistant.

12. A speech input system comprising:
a main device having:
a speech recognition system;
a first command transmitter electrically connected with the speech recognition system; and
a first command receiver electrically connected with the speech recognition system; and
a wireless electronic device wirelessly communicating with the main device and having:
a second command transmitter;
a second command receiver electrically connected with the second command transmitter;
a key electrically connected with second command transmitter;
a sound device electrically connected with the second command receiver; and
a speech receiver electrically connected with the second command transmitter.

13. The speech input system according to claim 12, wherein the wireless electronic device is a headset.

14. The speech input system according to claim 12, wherein the main device is a mobile phone.

15. The speech input system according to claim 12, wherein the main device is a personal digital assistant.
